(19) United States
(12) Patent Application Publication
(10) Pub. No.: US 2013/0025115 A1
(43) Pub. Date: Jan. 31, 2013

(54) WIRELESS SENSOR UNIT AND A MAINTENANCE METHOD FOR A WIRELESS SENSOR

(71) Applicant: Lars Stormbom, Vantaa (FI)

(72) Inventor: Lars Stormbom, Vantaa (FI)

(73) Assignee: VAISALA OYJ, HELSINKI (FI)

(21) Appl. No.: 13/575,386

(22) PCT Filed: Feb. 19, 2010
(86) PCT No.: PCT/FI2010/050109

§ 371 Date: Oct. 10, 2012

(51) Int. Cl. G01N 27/416; B23P 6/00

(52) U.S. Cl. 29/592.1; 204/400; 204/406

(57) ABSTRACT

A wireless sensor unit and a maintenance method. The sensor unit includes a sensor capable of forming a measurement signal, electronics capable of receiving a measurement signal from the sensor and sending the signal wirelessly to a wireless network, and a power supply for providing supply voltage for the sensor and electronics. The unit is divided into two parts, a first part and a second part such that the first part includes the electronics and is may be mounted permanently to a fixed object like a wall, and second part including the power supply and the sensor. The second part is capable to be repeatedly mounted and detached to the first part.

The present invention relates to a wireless sensor according to the preamble of claim 1.

The invention also relates to a maintenance method for a wireless sensor.

Wireless sensors are often battery powered, but then the lifetime is limited to 3-5 years after which battery replacement is required. Typically 1-2 Li-batteries are used with a cost of approximately 10 [symbol] for a sensor unit. Battery replacement is a costly housekeeping chore limiting the success of wireless sensor systems. Also sensors and measurement circuits need calibration in order to retain their accuracy.

The invention is intended to eliminate at least some defects of the state of the art disclosed above and for this purpose create an entirely new type of a wireless sensor unit and a maintenance method for wireless sensors.

The invention is based on separating sensor unit into two detachable parts where one part includes batteries and the sensor and the other part the rest of the sensor unit.

In one preferred embodiment battery powered wireless sensor unit comprises at least two parts, where a first part contains least the transmission means like radio and all parts necessary to specify the identity of the sensor unit in a wireless network and a second part containing batteries and at least all the parts necessary for performing the measurement and optionally calibration.

The second part may be attached at least a partially to the enclosure of the sensor unit.

Advantageously the first and the second part are connected to each other by a connector so that the connector automatically connects the two parts electrically when the enclosure is closed by attaching the second part.

In one preferred embodiment the sensor element, the measuring element is an electrochemical cell.

In a further preferred embodiment the first part of the sensor unit is attached to the wall of a room or a ventilation duct.

More specifically, the sensor unit according to the invention is characterized by what is stated in the characterizing portion of claim 1.

The method according to the invention is, in turn, characterized by what is stated in the characterizing portion of claim 9.

Considerable advantages are gained with the aid of the invention.

For the end user the benefits are the following. The sensor structure with batteries installed in the sensor unit lid makes the battery change fast and economical. No tools are required in the installing operation. Measurement integrity is also preserved as a new calibrated sensor and measurement circuit are provided at the same time. Further, there is no need to for any setup as the sensor identity is preserved in the radio part. Recycling of old batteries can be made easy by offering free return shipping. By the same time also scuffed and faded lids will be replaced with new ones.

For the manufacturing company the advantages are the following. The modularity of the sensor unit enables replacement as a part of business model. Revenue may be obtained both from new sensors and replacement parts as well. The invention also enables recycling of the sensor units, especially the removable lids. The manufacturing company gets also a price advantage as large volumes of batteries and sensor units are purchased. Additional benefit may be obtained because in the replacing stage of the sensor and batteries an expensive radio is not replaced.

When more expensive sensors are used in connection with the invention, the invention also offers a possibility organize effective procedure to replace aged sensor with a factory calibrated sensor in connection with battery replacement. The ole sensor may then be easily delivered for factory calibration at the same time the batteries are replaced by new ones.

In the following, the invention is examined with the aid of examples and with reference to the accompanying drawings.

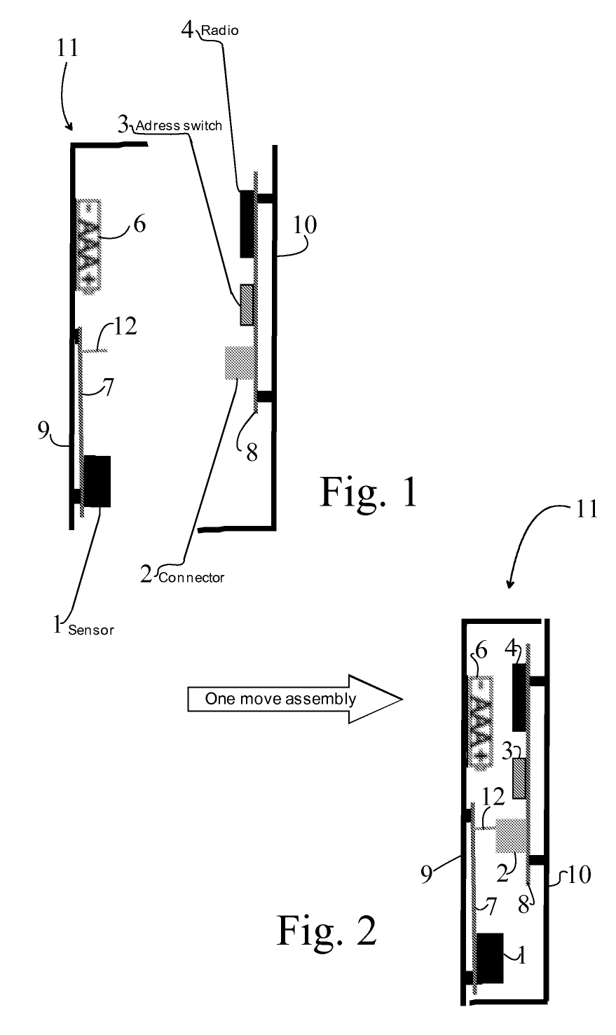

FIG. 1 shows as a cross sectioned side view one sensor unit in two parts in accordance with the invention.

FIG. 2 shows the sensor unit of FIG. 1 assembled as one piece according to the invention.

Some sensors, i.e., electrochemical cells that are advantageous for wireless sensors due to their low power consumption. Electrochemical cells also have a limited lifetime of a few years and therefore they need updating with this interval. Therefore the present invention is especially suitable for this type of sensors.

Electrochemical sensors are typically used to detect oxygen and other gases. Each sensor is designed to be specific to the gas it is intended to detect. Electrochemical sensors are typically fuel cells composed of noble metal electrodes in an electrolyte. The electrolyte is normally an aqueous solution of strong inorganic acids. When a gas is detected the cell sensor generates a small current proportional to the concentration of the gas. An electrochemical sensor consists of a diffusion barrier, a sensing-electrode, a counter-electrode and an electrolyte.

The invention is advantageously implemented in accordance with FIG. 1, where the sensor unit 11 comprises a lid 9 and a mounting housing 10 to be attached to wall, ceiling or floor of the space where measurement takes place. The lid 11 is typically connected to the mounting housing 10 by form fits or like, which can be opened without tools. In other words the connection between the lid 11 and housing 10 can be implemented in a way known from mobile phone covers. These connecting means are not shown in the figures. The lid 11 comprises typically the replaceable parts like batteries 6 and typically a sensor 1. The sensor 1 is mounted on a circuit board 7 and includes a contact element 12 for electrical contact with the connector 2 of the mounting housing 10. The contact element 12 includes also wiring for the battery 6 so that supply energy may be connected to the electrical elements located on the mounting housing 10. The circuit board 7 can be replaced by forming the lid 11, which forms as a part of the sensor unit 11 enclosure, as a circuit board with required connections for the sensor 1 and batteries 6. Advantageously the sensor 1 is an electrochemical sensor but also other sensor types can be used. When other types of sensors 1 are used, the lid 11 with batteries 6 and sensor 1 can be sent to factory for battery replacement and for sensor calibration and a new calibrated sensor with fresh batteries may be installed immediately. In case of electrochemical batteries the lid 11 with the batteries and sensor may be recycled directly, because the sensor is end of its life cycle.

Now referring to FIG. 2 where the lid 11 is mounted on the mounting housing 10, the contact element 12 forms contact with the connector 2 of the mounting housing 10. Hereby supply voltage from the batteries 6 and measurement signal from the sensor 1 is connected to electronics of the mounting housing 10. The electronics 3 and 4 on the mounting housing 10 are situated on a circuit board 8 and like in connection with the lid 11, also the housing 10 forming part of the sensor unit 11 enclosure can be formed such that it directly functions as a circuit board. The electronics comprises typically address switch 3, which defines the address of the sensor unit 11 in the wireless network. Further the electronics includes wireless radio 4 for transmitting the measurement and control information from and to the wireless network. The electronics may include suitable modules for processing the information from the sensor 1 for example in form of a microcontroller. The address switch 4 may also be implemented by software and be included in non-volatile memory located in the housing electronics so that when the lid 11 is removed the address of the sensor unit remains intact even when the supply voltage is not anymore present.

Other types of sensors than electrochemical cells may be used in connection with the invention. For example, capacitive sensors like capacitive humidity sensors suit well for the invention.

1. A wireless sensor unit comprising
a sensor capable of forming a measurement signal,
electronics capable of receiving a measurement signal from the sensor and sending the signal wirelessly to a wireless network, and
a power supply for providing supply voltage for the sensor and electronics,
wherein
the unit is divided into two parts, first part and second part such that
first part includes the electronics and is adapted to be mounted permanently to a fixed object like a wall, and
second part including the power supply and the sensor, the second part being capable to be repeatedly mounted and detached to and from the first part.

2. A sensor unit in accordance with claim 1, wherein second part is formed as a detachable lid on which the power supply and the sensor are attached.

3. A sensor unit in accordance with claim 1, wherein the first and the second part are connected to each other by a electric connector so that the connector automatically connects the two parts electrically when the second part is attached to the first part.

4. A sensor unit in accordance with claim 1, wherein the sensor is an electrochemical cell.

5. A sensor unit in accordance with claim 1, wherein the first part of the sensor unit is attached to the wall of a room or a ventilation duct.

6. A sensor unit in accordance with claim 1, wherein the sensor unit enclosure is used at least partially as a circuit board.

7. A sensor unit in accordance with claim 1, wherein the electronics include mechanical means for defining the network address of the sensor unit.

8. A sensor unit in accordance with claim 1, wherein the electronics include non-volatile memory for defining the network address of the sensor unit.

9. A maintenance method for a wireless sensor unit for replacing battery and calibrating a sensor,
wherein
replacing part of the sensor unit with a new part including both fresh battery and calibrated sensor.

10. A method in accordance with claim 9, wherein replaced old part is recycled.

11. A method in accordance with claim 9, wherein replaced old part is sent for factory calibration.

12. A sensor unit in accordance with claim 2, wherein the first and the second part are connected to each other by a electric connector so that the connector automatically connects the two parts electrically when the second part is attached to the first part.

13. A sensor unit in accordance with claim 2, wherein the sensor is an electrochemical cell.

14. A sensor unit in accordance with claim 3, wherein the sensor is an electrochemical cell.

15. A sensor unit in accordance with claim 2, wherein the first part of the sensor unit is attached to the wall of a room or a ventilation duct.

16. A sensor unit in accordance with claim 3, wherein the first part of the sensor unit is attached to the wall of a room or a ventilation duct.

17. A sensor unit in accordance with claim 4, wherein the first part of the sensor unit is attached to the wall of a room or a ventilation duct.

18. A sensor unit in accordance with claim 2, wherein the sensor unit enclosure is used at least partially as a circuit board.

19. A sensor unit in accordance with claim 3, wherein the sensor unit enclosure is used at least partially as a circuit board.

20. A sensor unit in accordance with claim 4, wherein the sensor unit enclosure is used at least partially as a circuit board.
